(19) United States
(12) Patent Application Publication
(10) Pub. No.: US 2025/0060129 A1
(43) Pub. Date: Feb. 20, 2025

(54) Integrated Components of Heating Element and Control Device for Air Heating Apparatus

(71) Applicant: Guyland Technologies (HongKong) Limited, Hong Kong (HK)

(72) Inventor: Tianyu GAO, Shenzen (CN)

(21) Appl. No.: 18/419,421

(22) Filed: Jan. 22, 2024

(30) Foreign Application Priority Data
Aug. 17, 2023 (CN) 2023110447171

(51) Int. Cl. F24H 3/04; F24H 15/128; H05B 3/06

(52) U.S. Cl. CPC F24H 3/0405; F24H 15/128; H05B 3/06; F24H 2250/04; H05B 2203/02

(57) ABSTRACT

A heating apparatus includes an outer case, a fan received in the outer case, and an integrated heating unit received in the outer case. The integrated heating unit includes a heating device and a control module integrally connected to the heating device for forming an integrated heating unit without using any electrical wirc.

### CROSS REFERENCE OF RELATED APPLICATION

This is a non-provisional application which claimed priority of Chinese application number 2023110447171, filing date Aug. 17, 2023. The contents of this specification, including any intervening amendments thereto, are incorporated herein by reference.

### BACKGROUND OF THE PRESENT INVENTION

### Field of Invention

The present invention relates to a heating device, and more particularly to an integrated component of the heating element and control device of an air heating device that is easy to allow automated assembling.

### Description of Related Arts

Heating Apparatuses, such as heating fans, water heaters, electric kettles and the likes, have widely been used around the world. A common feature of these heating apparatuses is that all of them have some sorts of heating assemblies and control modules. No matter the objects of heating, the control modules are responsible for controlling the operation of the heating assemblies so as to prevent overheating and damage to the heating apparatuses. For example, for a typical heating fan, the positive temperature coefficient (PTC) heating element must be electrically connected to a temperature control module. Conventionally, such electrical connections are accomplished by using electrical wires. However, this traditional connection mechanism requires complicated and time-consuming manufacturing procedures, and cannot be accomplished using automated systems.

Therefore, the efficiency of manufacturing these conventional heating apparatuses is relatively low. The quality of the end products is rather unstable.

### SUMMARY OF THE PRESENT INVENTION

Certain variations of the present invention provide an integrated component of the heating element and control device of an air heating device, which directly connects or inserts the connecting terminals or ports of the heating element and that of the control device, so that the air heating device can be assembled and processed through automated equipment. This greatly improves assembling efficiency and reduces production costs, and ensures consistently high product quality.

In one aspect of the present invention, it provides a heating apparatus, comprising:
an outer case;
a fan received in the outer case; and
an integrated heating unit which is received in the outer case, and comprises a heating device and a control module integrally connected to the heating device for forming the integrated heating unit without using an electrical wire.

This summary presented above is provided merely to introduce certain concepts and not to identify any key or essential features of the claimed subject matter.

### BRIEF DESCRIPTION OF THE DRAWINGS

FIG. 1 is a perspective view of integrated components of heating element and

control device of an integrated heating unit according to a preferred embodiment of the present invention.

FIG. 2 is an exploded perspective view of the integrated heating unit of the heating apparatus according to a preferred embodiment of the present invention.

FIG. 3 is a block diagram illustrating control circuitry of the integrated heating unit according to the preferred embodiment of the present invention.

FIG. 4 is a schematic diagram of the heating apparatus according to the preferred embodiment of the present invention.

FIG. 5 illustrates an alternative mode of the integrated components of heating element and control device of an integrated heating unit according to a preferred embodiment of the present invention.

FIG. 6 is an exploded perspective view of integrated components of heating element and control device of an integrated heating unit according to a preferred embodiment of the present invention.

### Detailed Descriptions of the Present Invention

The following detailed description of the preferred embodiment is the preferred mode of carrying out the invention. The description is not to be taken in any limiting sense. It is presented for the purpose of illustrating the general principles of the present invention.

In the following descriptions, it should also be appreciated that the terms “arrange” and “set” in the following description refer to the connecting relationship in the accompanying drawings for easy understanding of the present invention. For example, the “arrange” and “set” may refer to one element directly or indirectly set or arrange on another element. Therefore, the above terms should not be an actual connection limitation of the elements of the present invention.

It should also be appreciated that the terms “center”, “length”, “width”, “thickness”, “top”, “bottom”, “front”, “rear”, “left”, “right”, vertical ”, “horizontal”, “upper”, “lower”, “interior”, and “exterior” in the following description refer to the orientation or positioning relationship in the accompanying drawings for easy understanding of the present invention without limiting the actual location or orientation of the present invention. Therefore, the above terms should not be an actual location limitation of the elements of the present invention.

Moreover, it should be appreciated that the terms “first”, “second”, “one”, “a”, and “an” in the following description refer to “at least one” or “one or more” in the embodiment. In particular, the term “a” in one embodiment may refer to “one” while in another embodiment may refer to “more than one”. Therefore, the above terms should not be an actual numerical limitation of the elements of the present invention.

It should be appreciated that the terms “install”, “connect”, “couple”, and “mount” in the following description refer to the connecting relationship in the accompanying drawings for easy understanding of the present invention. For example, the connection may refer to permanent connection or detachable connection. Therefore, the above terms should not be an actual connection limitation of the elements of the present invention.

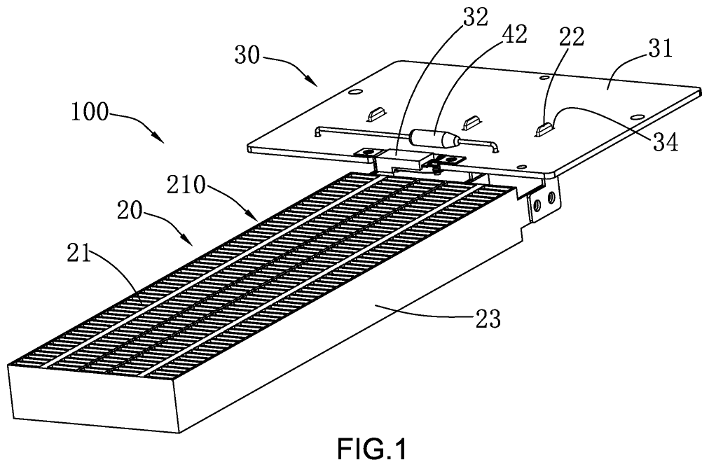

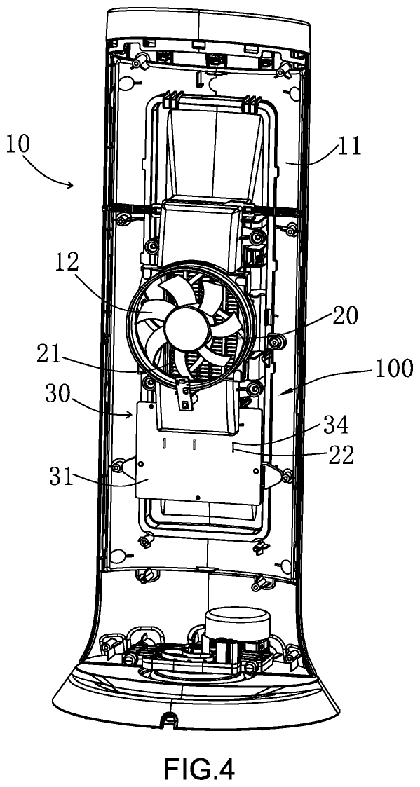

Referring to FIG. 1to FIG. 4 of the drawings, a heating apparatus 10, such as a heating fan, according to a preferred embodiment of the present invention, is illustrated. Broadly, the heating apparatus 10 comprises an outer case 11, a fan 12 received in the outer case 11, and an integrated heating unit 100 also received in the outer case 11. The integrated heating unit100 comprises a heating device 20 and a control module 30 integrally connected to the heating device 20 for forming the integrated heating unit 100.

The heating apparatus 10 may take a wide variety of forms, and its purpose is to heat up incoming air and deliver the heated air to an ambient environment. An example of the heating apparatus 10 is a heating fan. The heating device 20 is arranged to heat incoming air, while the control module 30 is arranged to control the operation of the heating device 20. The heating device 20 and the control module 30 are electrically connected together without the use of electrical wires.

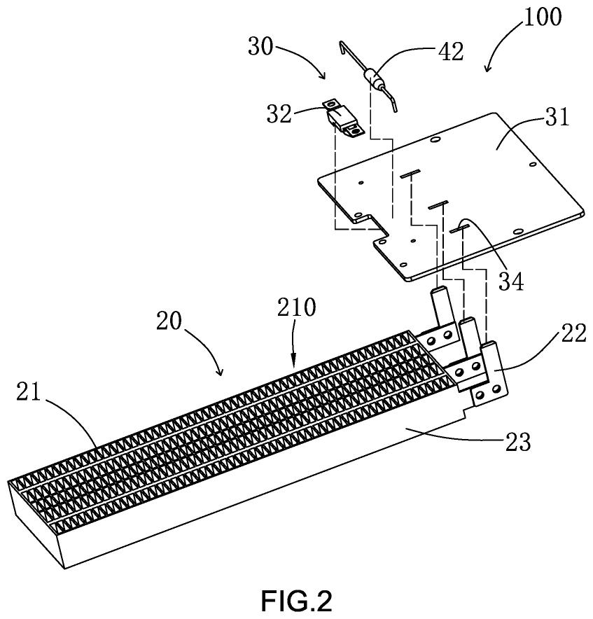

The heating device 20 may comprise at least one of a positive temperature coefficient (PTC) heating element, a heating tube, and a heating coil. In this preferred embodiment, the heating device 20 may comprise a plurality of positive temperature coefficient (PTC) heating elements 21 connected in parallel. A supporting frame 23 may be utilized to provide support to the PTC heating elements 21. As shown in FIG. 2 of the drawings, the supporting frame 23 has a rectangular structure, in which the PTC heating elements 21 are mounted on the supporting frame 23 to form an array of PTC heating elements 21.

The positive temperature coefficient (PTC) heating elements 21 may be connected into three individual heating assemblies 210 connected in parallel. FIG. 2 illustrates that the PTC heating elements 21 may be arranged to form three columns, in which each column of the PTC heating elements 21 forms a heating assembly 210. Each of the three heating assemblies 210 may have a connecting terminal 22 connecting to the PTC heating elements 21 of that particular heating assembly 210. The connecting terminals 22 may extend from the supporting frame 23 toward the control module 30.

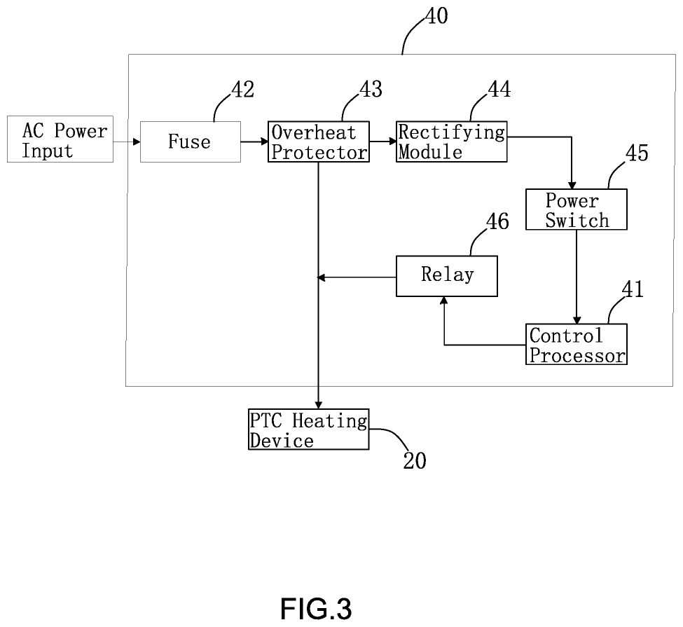

Referring to FIG. 1 to FIG. 3 of the drawings, the control module 30 comprises a control circuit board 31 implementing a control circuity 40, and a thermostat 32 electrically connected to the control circuitry 40 and implemented on the control circuity board 31. As shown in FIG. 3 of the drawings, the control circuitry 40 comprises a control processor 41, a fuse 42, an overheat protector 43, and a rectifying module 44, a power switch 45 and a relay 46. The thermostat 32 is arranged to control the temperature for the PTC heating elements 21 according to a predetermined temperature threshold thereof.

The control processor 41 is configured to process temperature data collected from the overheat protector 43, and control the electrical current supplied to the PTC heating elements 21 through the relay 46. The overheat protector 43 may be configured as a temperature sensor. The overheat protector 43 and the fuse 42 are utilized for preventing overheating of the PTC heating elements 21. As shown in FIG. 1 of the drawings, the fuse 42 is implemented and welded on the control circuit board 31, and is electrically connected to an external AC input. When the current supplied to the heating apparatus 10 reaches a predetermined threshold, the fuse 42 is arranged to cut off the electricity so as to prevent damage to the components of the heating apparatus.

As shown in FIG. 1 and FIG. 4 of the drawings, the control processor 41 is electrically connected to the power switch 45 and the relay 46. Moreover, the relay 46 is electrically connected between the overheat protector 43 and the PTC heating elements 21. When the temperature of the PTC heating elements 21 reaches a predetermined threshold, the relay 46 is arranged to cut off the electricity supplied to the PTC heating elements 21 as controlled by the control processor 41 so as to prevent the PTC heating elements 21 from being damaged by excessive high temperature. The rectifying module 44 is electrically connected between the overheat protector 43 and the power switch 45.

The control circuit board 31 has a plurality of connecting ports 34 for connecting to the connecting terminals 22 of the of the heating assemblies 210 respectively. In this preferred embodiment of the present invention, the control circuit board 31 has three connecting ports 34, wherein three connecting terminals 22 are electrically connected to the three connecting ports 34 respectively. Each of the connecting terminals 22 is welded to the corresponding connecting port 34 so as to form a secure connection between the heating assemblies 210 and the control circuit board 31. As such, the heating device 20 and the control module 30 are securely connected without using conventional electrical wires.

It is worth mentioning that since the heating device 20 and the control module 30 are securely connected without using conventional electrical wires, the heating device 20 and the control module 30 may be manufactured by automated manufacturing system and this substantially increases the efficiency of the entire manufacturing process of the present invention.

As shown in FIG. 4 of the drawings, the control module 30 of the integrated heating unit 100 may be mounted in the outer case 11, wherein the heating device 20 may be connected in the outer case 11 at a position behind (i.e. overlapping with) the fan 12. Thus, the air generated by the fan 12 can be heated by the heating device 20 which is in the vicinity of the fan 12. The heating device 20 and the control module 30 may be assembled through an automated manufacturing system before being assembled in the outer case 11.

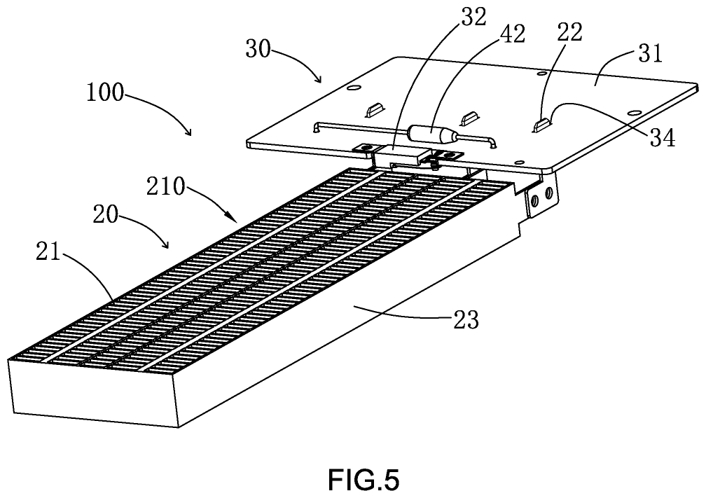

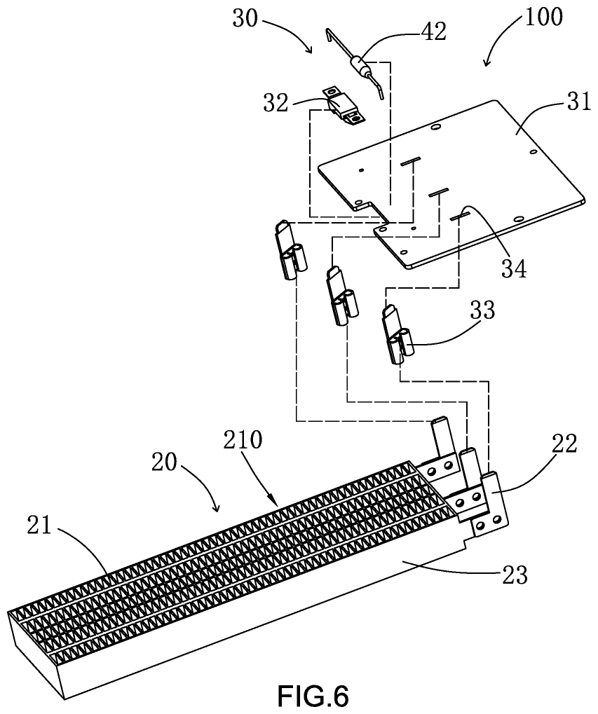

Referring to FIG. 5 to FIG. 6 of the drawings, an alternative mode of the heating apparatus 10 according to the preferred embodiment of the present invention is illustrated. The alternative mode is similar to the preferred embodiment described above, except the heating apparatus further comprises a plurality of connecting adapters 33 welded to the control circuit board 31, wherein the connecting terminals 22 are arranged to insert and connect to the connecting adaptors 33 respectively for connecting to the control circuit board 31.

Thus, the connecting adapters 33 may act as intermediate components for connecting the connecting terminals 22 to the control circuit board 31. The connecting adapters 33 are securely welded to the control circuit board 31 to electrically connect to the control circuitry 40, while the connecting terminals 22 are inserted to the connecting adapters 33 respectively to electrically connect to the control circuitry 40.

The present invention, while illustrated and described in terms of a preferred embodiment and several alternatives, is not limited to the particular description contained in this specification. Additional alternative or equivalent components could also be used to practice the present invention.

What is claimed is:

1. A heating apparatus, comprising:
an outer case;
a fan received in the outer case; and
an integrated heating unit which is received in the outer case, and comprises a heating device and a control module integrally connected to the heating device without using an electrical wire.

2. The heating apparatus, as recited in claim 1, wherein the heating device comprises a supporting frame, and a plurality of positive temperature coefficient heating elements mounted on the supporting frame, the positive temperature coefficient heating elements being arranged in an array on the supporting frame to form at least one heating assembly.

3. The heating apparatus, as recited in claim 2, wherein the heating assembly comprises a connecting terminal connecting to the positive temperature coefficient heating elements, the connecting terminal extending from the supporting frame and electrically connecting to the control module without using the electrical wire.

4. The heating apparatus, as recited in claim 3, wherein the control module comprises a control circuit board, a control circuitry implementing on the control circuit board, and a thermostat electrically connected to the control circuitry and implemented on the control circuity board.

5. The heating apparatus, as recited in claim 4, wherein the control circuitry comprises a control processor, an overheat protector, and a relay, the control processor being configured to process temperature data collected from the overheat protector, and control the electrical current supplied to the positive temperature coefficient heating elements through the relay, the overheat protector being configured as a temperature sensor.

6. The heating apparatus, as recited in claim 5, wherein the control module further comprises a power switch, wherein the relay is electrically connected between the overheat protector and the positive temperature coefficient heating elements, wherein when the temperature of the positive temperature coefficient heating elements reaches a predetermined threshold, the relay is arranged to cut off electricity supplied to the positive temperature coefficient heating elements as controlled by the control processor so as to prevent the positive temperature coefficient heating elements from being damaged by excessive high temperature.

7. The heating apparatus, as recited in claim 6, wherein the control circuit board has at least one connecting port for connecting to the connecting terminal of the heating assembly, the connecting terminal being welded to the connecting port so as to form secure connection between the heating assembly and the control circuit board without using an electrical wire.

8. The heating apparatus, as recited in claim 4, wherein the heating apparatus further comprises at least one connecting adapter welded to the control circuit board, wherein the connecting terminal is arranged to insert to the connecting adapter for connecting to the control circuit board through the connecting adapter.

9. The heating apparatus, as recited in claim 8, wherein the control circuitry comprises a control processor, an overheat protector, and a relay, the control processor being configured to process temperature data collected from the overheat protector, and control the electrical current supplied to the positive temperature coefficient heating elements through the relay, the overheat protector being configured as a temperature sensor.

10. The heating apparatus, as recited in claim 9, wherein the control module further comprises a power switch, wherein the relay is electrically connected between the overheat protector and the positive temperature coefficient heating elements, wherein when the temperature of the positive temperature coefficient heating elements reaches a predetermined threshold, the relay is arranged to cut off electricity supplied to the positive temperature coefficient heating elements as controlled by the control processor so as to prevent the positive temperature coefficient heating elements from being damaged by excessive high temperature.

11. The heating apparatus, as recited in claim 10, wherein the control circuit board has at least one connecting port for connecting to the connecting terminal of the heating assembly, the connecting terminal being welded to the connecting port so as to form secure connection between the heating assembly and the control circuit board without using an electrical wire.
